(19) United States
(12) Patent Application Publication
(10) Pub. No.: US 2010/0264027 A1
(43) Pub. Date: Oct. 21, 2010

(54) GAS SENSOR

(75) Inventors: Masaki NAKAGAWA, Nagoya-shi (JP); Tomohiro WAKAZONO, Nagoya-shi (JP); Seiji OYA, Nagoya-shi (JP)

Correspondence Address: SUGHRUE MION, PLLC, 2100 PENNSYLVANIA AVENUE, N.W., SUITE 800, WASHINGTON, DC, 20037, US

(73) Assignee: NGK SPARK CO., LTD., Aichi (JP)

(21) Appl. No.: 12/760,958

(22) Filed: Apr. 15, 2010

(30) Foreign Application Priority Data
Apr. 17, 2009 (JP) 2009-100451
Mar. 8, 2010 (JP) 2010-050193

(51) Int. Cl. G01N 27/30

(52) U.S. Cl. 204/431

(57) ABSTRACT

A gas sensor including a gas sensor element configured by laminating three or more ceramic layers and having an electrode pad disposed on an outer surface thereof and penetrating holes extending in a laminating direction through two or more of the ceramic layers disposed between an inner conductor and the electrode pad. The gas sensor element has a conductive path formed therein which passes through the penetrating holes formed in different respective ones of the ceramic layers and electrically connects the inner conductor and the electrode pad. Further, the conductive pad is a type 1 conductive path which passes through a plurality of the penetrating holes disposed so as not to overlie one another as viewed from the laminating direction.

### BACKGROUND OF THE INVENTION

1. Field of the Invention

The present invention relates to a gas sensor.

2. Description of the Related Art

Conventionally, gas sensors have been utilized for detecting particular gas components, such as nitrogen oxides (NOₓ) and oxygen, and for measuring the concentration of particular gas components. Among these gas sensors, a gas sensor is known that uses an elongated plate-like gas sensor element including a plurality of laminated ceramic layers (e.g., solid electrolyte layers and alumina substrates). A known technique for connecting inner conductors (e.g., a heat-generating resistor and electrodes) of the gas sensor element to corresponding electrode pads provided on the surface of the gas sensor element uses penetrating holes extending through individual ones of the laminated ceramic layers (e.g., through holes and via holes) and conductive paths extending through a plurality of the penetrating holes.

[Patent Document 1] Japanese Patent Application Laid-Open (kokai) No. 2007-40820

[Patent Document 2] Japanese Patent Application Laid-Open (kokai) No. 2008-170341

3. Problems to be Solved by the Invention

When two or more ceramic layers are disposed between an inner conductor and a corresponding electrode pad provided on the surface of the gas sensor element, a penetrating hole must be provided in each of the ceramic layers. According to the gas sensors of Patent Documents 1 and 2, as viewed from the laminating direction of the gas sensor elements, the penetrating holes provided in the respective ceramic layers overlie one another (the penetrating holes are aligned with one another in the laminating direction). However, such a configuration is likely to generate cracks in the gas sensor elements starting from the aligned penetrating holes upon vibration of the gas sensor elements induced by external shock or vibration.

### SUMMARY OF THE INVENTION

The present invention has been achieved in view of the above-mentioned problem, and an object thereof is to provide a technique for retaining strength of the gas sensor element by restraining the generation of cracks or the like in a gas sensor element even when the gas sensor element is subjected to external shock or vibration.

The above object has been achieved, in accordance with a first aspect (1) of the invention, by providing a gas sensor comprising a gas sensor element having a form of a plate extending in a longitudinal direction and configured by laminating three or more ceramic layers, the gas sensor element having an electrode pad disposed on an outer surface thereof, and penetrating holes extending in the laminating direction through two or more respective ones of the ceramic layers disposed between an inner conductor provided in the gas sensor element and the electrode pad, wherein the gas sensor element has a conductive path formed therein which passes through the penetrating holes formed in different respective ones of the ceramic layers and electrically connects the inner conductor and the electrode pad, and the conductive path comprises a type 1 conductive path which passes through a plurality of the penetrating holes disposed so as not to overlie one another as viewed from the laminating direction.

According to the above-described configuration, as viewed from the laminating direction, a plurality of the penetrating holes used to form the type 1 conductive path passes are not disposed on the same straight line in parallel with the laminating direction. Thus, even when the gas sensor element vibrates as a result of exposure to external shock or vibration, the generation of cracks or the like is restrained, whereby the strength of the gas sensor element can be retained. As used herein, the expression “penetrating holes are disposed so as not to overlie one another as viewed from the laminating direction” means that, when the penetrating holes formed in the ceramic layers are projected in the laminating direction onto an outermost ceramic layer, the penetrating holes are disposed at different positions (i.e., the projected penetrating holes are disposed so as not to come into contact with one another). Preferably, the three or more ceramic layers include a support layer for supporting a heat-generating resistor, and a solid electrolyte layer having a pair of electrodes. Preferably, the inner conductor is the heat-generating resistor or one of the paired electrodes.

In a preferred embodiment (2) according to (1) above, the gas sensor further comprises a terminal in contact with the electrode pad and adapted to connect the electrode pad to an external circuit, and a holding section for holding the gas sensor element, wherein the type 1 conductive path is disposed within a positional range between a contact position where the terminal is in contact with the electrode pad and a holding position where the holding section holds the gas sensor element.

In the case where a conductive path is provided within a positional range between the contact position and the holding position, when one of the contact position and the holding position is subjected to external shock or vibration, the gas sensor element vibrates with the other one of the contact position and the holding position serving as a fixed end. As a result, cracking or the like is likely to occur, starting from a penetrating hole disposed within the positional range between the contact position and the holding position. However, according to the above-described configuration, since the type 1 conductive path is disposed within the positional range between the contact position and the holding position, even when the gas sensor element vibrates as a result of exposure to external shock or vibration, the generation of cracks or the like starting from a penetrating hole disposed within the positional range between the contact position and the holding position is restrained, whereby the strength of the gas sensor element can be retained. According to a preferable mode, the position along the longitudinal direction of at least one of a plurality of the penetrating holes through which the type 1 conductive path passes is located within the positional range between the contact position where the terminal and the electrode pad are in contact with each other and the holding position where the holding section holds the gas sensor element.

In another preferred embodiment (3) of the gas sensor according to (1) or (2) above, as viewed from the laminating direction, a plurality of the penetrating holes through which the type 1 conductive path passes are positionally shifted from one another at least in the longitudinal direction.

According to the above-described configuration, a plurality of the penetrating holes through which the type 1 conductive path passes are not disposed along a lateral direction (the width direction of the gas sensor element) perpendicular to the longitudinal direction. Thus, this configuration, as viewed on an imaginary section of the gas sensor element which is taken along the width direction and passes through one of a plurality of the penetrating holes used to form the type 1 conductive path, can prevent a problem of the gas sensor element having a region of an excessively high occupancy rate (areal rate) of penetrating holes. Accordingly, even when the gas sensor element vibrates as a result of exposure to external shock or vibration, the generation of cracks or the like is restrained, whereby the strength of the gas sensor element can be retained. As used herein, the expression “the penetrating holes . . . are positionally shifted from one another at least in the longitudinal direction” means that, when the penetrating holes formed in the respective ceramic layers are projected onto an outermost ceramic layer, the penetrating holes differ from one another in position at least in the longitudinal direction. As for position in the width direction (a direction perpendicular to the longitudinal direction), the penetrating holes may differ from one another, or at least some of the penetrating holes may be located at the same position. For example, the penetrating holes may be disposed on the same straight line in parallel with the longitudinal direction or may be disposed on a straight line which acutely intersects the longitudinal direction.

In yet another preferred embodiment (4) of the gas sensor according to any one of (1) to (3) above, the gas sensor element comprises a plurality of electrode pads, and an outermost layer serving as the outer surface thereof and in contact with the plurality of the electrode pads; the outermost layer has a plurality of penetrating holes formed therein; and of pairs each consisting of any two of the plurality of the penetrating holes formed in the outermost layer, a pair consisting of two penetrating holes located closest to each other is used to form two conductive paths passing through the respective penetrating holes, each of which is a type 1 conductive path.

When the gas sensor element vibrates as a result of exposure to external shock or vibration, cracking or the like is highly likely to occur, starting from two penetrating holes formed closest to each other in the outermost layer. However, according to the above-described configuration, the two conductive paths located closest to each other are type 1 conductive paths. Thus, even when the gas sensor element vibrates as a result of exposure to external shock or vibration, the generation of cracks or the like starting from two penetrating holes formed closest to each other in the outermost layer is restrained, whereby the strength of the gas sensor element can be retained.

In yet another preferred embodiment (5) of the gas sensor according to (4) above, all of a plurality of the conductive paths passing through a plurality of the respective penetrating holes formed in the outermost layer are type 1 conductive paths.

According to the above-described configuration, as viewed from the laminating direction, the penetrating holes are never disposed on the same straight line in parallel with the laminating direction, Thus, even when the gas sensor element vibrates as a result of exposure to external shock or vibration, the generation of cracks or the like is restrained, whereby the strength of the gas sensor element can be retained.

In yet another preferred embodiment (6) of the gas sensor (4) above, as viewed on an imaginary section of the gas sensor element taken perpendicular to the longitudinal direction, the number of penetrating holes present in each of the ceramic layers is at most one.

According to the above-described configuration, as viewed on an imaginary section of the gas sensor element taken perpendicular to the longitudinal direction, a plurality of the penetrating holes are not present in each of the ceramic layers, thereby preventing a problem, as viewed on the imaginary section, of the gas sensor element having a region of an excessively high occupancy rate (areal rate) of penetrating holes. Accordingly, even when the gas sensor element vibrates as a result of exposure to external shock or vibration, the generation of cracks or the like is sufficiently restrained, whereby the strength of the gas sensor element can be sufficiently retained. Preferably, as viewed on an imaginary section of the gas sensor element taken perpendicular to the longitudinal direction, the total number of the penetrating holes present in all of the ceramic layers (the total number of the penetrating holes intersecting with a single imaginary section) is at most one.

In yet another preferred embodiment (7) of the gas sensor according to (4) above, the outermost layer contains alumina as a main component; the gas sensor element further comprises a solid electrolyte layer; and the distance between the two of the plurality of the penetrating holes located closest to each other and formed in the outermost layer is shorter than that between two penetrating holes which are formed in the solid electrolyte layer and through which the two respective type 1 conductive paths, passing through the two penetrating holes of the outermost layer, pass.

According to the above-described configuration, the distance between the two penetrating holes formed in the solid electrolyte layer, through which the two respective type 1 conductive path pass, is longer than the distance between the two closest penetrating holes formed in the outermost layer, which contains alumina as a main component. Thus, leakage of current through the solid electrolyte layer can be restrained.

In yet another preferred embodiment (8) of the gas sensor according to (7) above, the inner conductor is at least one of a heat-generating resistor for heating the gas sensor element and a pair of electrodes provided on the solid electrolyte layer and partially constituting a cell.

The above-described configuration enables the present invention to be used for a conductive path which connects a heat-generating resistor or an electrode of the gas sensor element to an electrode pad provided on the surface of the gas sensor element. Configuration (8) can be applied to a gas sensor according to any one of the gas sensors of (1) to (6) above in which the gas sensor element further comprises a solid electrolyte layer.

The present invention can be embodied in various forms; for example, in a gas sensor element and a gas sensor using the gas sensor element.

### BRIEF DESCRIPTION OF THE DRAWINGS

FIG. 1 is a sectional view showing a gas sensor 200 according to an embodiment of the present invention.

FIG. 2 is a sectional view of an NOₓ sensor element 10.

FIG. 3 is an exploded perspective view of the NOₓ sensor element 10.

FIG. 4 is an explanatory view showing through hole positions as viewed from a laminating direction D2.

FIG. 5 is an explanatory view showing through hole positions as viewed from a lateral direction D3.

FIG. 6 is an exploded perspective view of another embodiment of an NOₓ sensor element.

FIG. 7 is an explanatory view showing through hole positions as viewed from the laminating direction D2.

FIG. 8 is an exploded perspective view of another embodiment of a gas sensor element.

FIG. 9 is a diagram showing the results of load evaluation conducted on samples of the first embodiment and samples of a comparative example.

### DESCRIPTION OF REFERENCE NUMERALS

Reference numerals used to identify various structural features in the drawings include the following.
10, 10A, 10B: gas sensor element
10BE: backward end
11: first pumping cell
11a: first solid electrolyte layer
11b: outer first pump electrode
11c: inner first pump electrode
11e: protection layer
11bL: connection line
11cL: pump electrode line
12: oxygen concentration detection cell
12a: second solid electrolyte layer
12b: detection electrode
12c: reference electrode
12bL: detection electrode line
12cL: first connection line
13: second pumping cell
13a: third solid electrolyte layer
13b: inner second pump electrode
13c: counter second pump electrode
13bL: third connection line
13cL: second connection line
14a: insulation layer
14b: insulation layer
14c: insulation layer
14d: insulation layer
14e: insulation layer
15a: first diffusion resistor
15b: second diffusion resistor
16: first measuring chamber
17: reference oxygen chamber
18: second measuring chamber
50: heater
50La, 50Lb: connection line
106: ceramic sleeve
110, 110P-110U: connection terminal
138: metallic shell
139: threaded portion
140: backward end portion
142: outer protector
143: inner protector
144: outer tube
146: lead wire
150: grommet
151: ceramic holder
152: ledge
153, 156: powder layer (talc ring)
154: through hole
157: packing
158: metal holder
160: holding section
161: lead wire insertion hole
166: insulation contact member
167: flange portion
168: contact insertion hole
169: holding member
200: gas sensor
PL1P: first connection line
PL1Q: second connection line
PL2P: first connection line
PL2Q: second connection line
PL4S: connection line
PL1Q: connection line
PL2Q: connection line
PL1V: connection line
PL5W: connection line
PL4W: connection line
CLSa: conductive path
PL5S: connection line
CLQa: type 1 conductive path
D1: longitudinal direction
D2: direction of lamination
D3: lateral direction
R1: first positional range
R2: second positional range
GM: gas to be measured
GN: gas to be measured
CU: control unit
C1P, C1Q, C1R, C1V, C2P, C2Q, C3P, C2V, C3Q, C4S, C4W, C5S, C5W, C6S, C6T, C6U, C6W: through hole
PR1: first pair
PR2: second pair
DT1: first distance
DT2: second distance
DT3: third distance
BWD: backward direction
FWD: forward direction
CLP, CLQ, CLQa, CLS, CLSa, CLU, CLW: conductive path
PdP, PdQ, PdR, PdS, PdU, PdV, PdW: electrode pad

### DETAILED DESCRIPTION OF THE PREFERRED EMBODIMENTS

Embodiments of the present invention will next be described by reference to the drawings and in the following sequence. However, the present invention should not be construed as being limited thereto.

A. First embodiment
B. Second embodiment
C. Third embodiment
D. Experimental examples

### E. Modifications

### A. First Embodiment

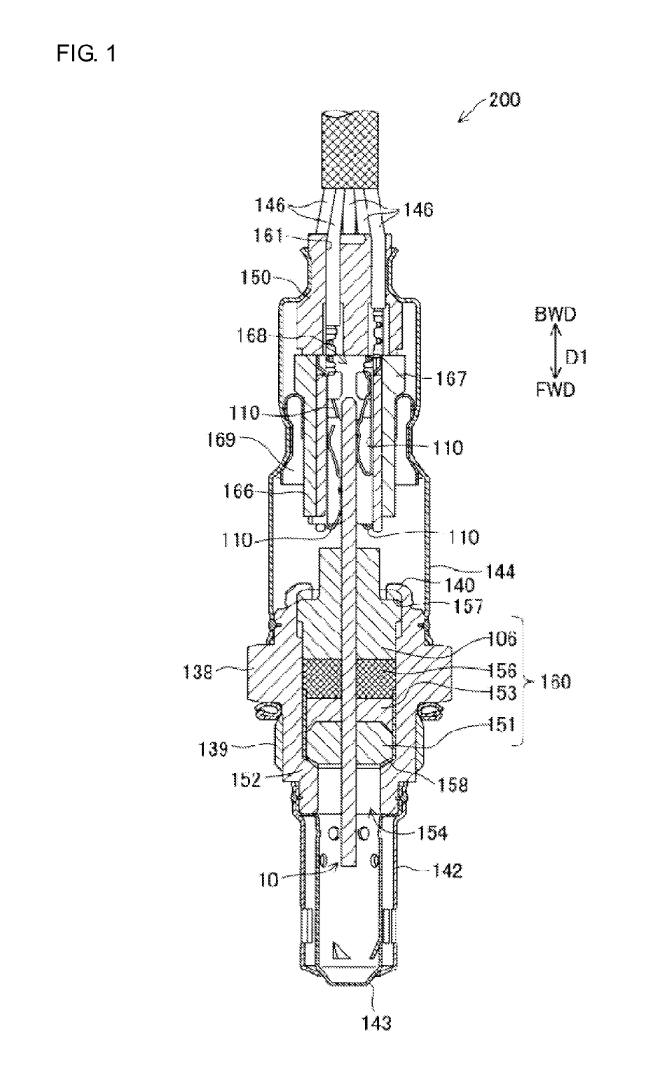

FIG. 1 is a sectional view showing a gas sensor 200 according to an embodiment of the present invention. The gas sensor 200 is fixed to an exhaust pipe of an unillustrated internal combustion engine and adapted to measure the concentration of nitrogen oxide (NOₓ) (hereinafter, also referred to as the “NOₓ sensor 200”). FIG. 1 shows a section of the NOₓ sensor 200 taken in parallel with a longitudinal direction D1. In the following description, the downward direction (lower side) in FIG. 1 is called the forward direction (forward side) FWD of the NOₓ sensor 200, and the upward direction (upper side) in FIG. 1 is called the backward direction (backward side) BWD of the NOₓ sensor 200.

The NOₓ sensor 200 includes a tubular metallic shell 138, a plate-like NOₓ sensor element (gas sensor element) 10 extending in the longitudinal direction D1, a tubular ceramic sleeve 106 surrounding the NOₓ sensor element 10, an insulation contact member 166, and six connection terminals 110 (four pieces illustrated in FIG. 1). The metallic shell 138 has a threaded portion 139 formed on the outer surface thereof and adapted to be fixed to the exhaust pipe. The ceramic sleeve 106 is disposed so as to surround the NOₓ sensor element 10 from a radial direction. The insulation contact member 166 has a contact insertion hole 168 extending therethrough in the longitudinal direction D1. The insulation contact member 166 is disposed in such a manner that the wall surface of the contact insertion hole 168 surrounds a backward end portion of the NOₓ sensor element 10. The connection terminals 110 are disposed between the NOₓ sensor element 10 and the insulation contact member 166.

The metallic shell 138 is formed into a substantially tubular shape and has a through hole 154 extending therethrough in an axial direction and a ledge 152 projecting radially inward in the through hole 154. The metallic shell 138 holds the NOₓ sensor element 10 in the through hole 154 in such a manner that the forward end of the NOₓ sensor element 10 is disposed externally of the through hole 154 on the forward side FWD, whereas the backward end of the NOₓ sensor element 10 is disposed externally of the through hole 154 on the backward side BWD. The ledge 152 includes a taper surface inclined from a plane perpendicular to the longitudinal direction D1. The taper surface is formed such that the diameter on the forward side FWD is smaller than the diameter on the backward side BWD.

A ceramic holder 151, powder layers 153 and 156 (hereinafter, also referred to as the talc rings 153 and 156), and the ceramic sleeve 106 are stacked in this order from the forward side toward the backward side in the through hole 154 of the metallic shell 138. The ceramic holder 151, the talc rings 153 and 156, and the ceramic sleeve 106 collectively correspond to the claimed “holding section.” Hereinafter, these members may be collectively called the “holding section 160.” Each of these members assumes an annular shape for surrounding the NOₓ sensor element 10 from a radial direction so as to hold the NOₓ sensor element 10. The NOₓ sensor element 10 is held by the holding section 160.

A crimp packing 157 is disposed between the ceramic sleeve 106 and a backward end portion 140 of the metallic shell 138. A metal holder 158 is disposed between the ceramic holder 151 and the ledge 152 of the metallic shell 138 for holding the talc ring 153 and the ceramic holder 151 and for maintaining gastightness. The backward end portion 140 of the metallic shell 138 is crimped so as to press the ceramic sleeve 106 forward via the crimp packing 157.

As shown in FIG. 1, an outer protector 142 and an inner protector 143 are attached to the outer circumference of a forward end portion (a lower end portion in FIG. 1) of the metallic shell 138 by welding or the like. The protectors 142 and 143 assembled in a dual structure are formed from metal (e.g., stainless steel) having a plurality of holes, and cover a projecting portion of the NOₓ sensor element 10.

An outer tube 144 is fixed to the outer circumference of a backward end of the metallic shell 138. A grommet 150 is disposed in a backward end (upper end in FIG. 1) opening portion of the outer tube 144. The grommet 150 has lead insertion holes 161 formed therein. Six lead wires 146 (only five lead wires 146 are shown in FIG. 1) are inserted through the respective lead insertion holes 161. These lead wires 146 are electrically connected to respective electrode pads provided on the outer surface of a backward end portion of the NOₓ sensor element 10.

The insulation contact member 166 is disposed around a backward end portion (upper end portion in FIG. 1) of the NOₓ sensor element 10 projecting from the backward end portion 140 of the metallic shell 138. The insulation contact member 166 is disposed around the electrode pads formed on the surface of the backward end portion of the NOₓ sensor element 10. The insulation contact member 166 assumes a tubular shape; has the contact insertion hole 168 extending therethrough in the longitudinal direction D1; and has a flange portion 167 projecting radially outward from the outer surface thereof. A holding member 169 is inserted between the insulation contact member 166 and the outer tube 144. The holding member 169 is in contact with the outer tube 144 and the flange portion 167, thereby holding the insulation contact member 166 within the outer tube 144.

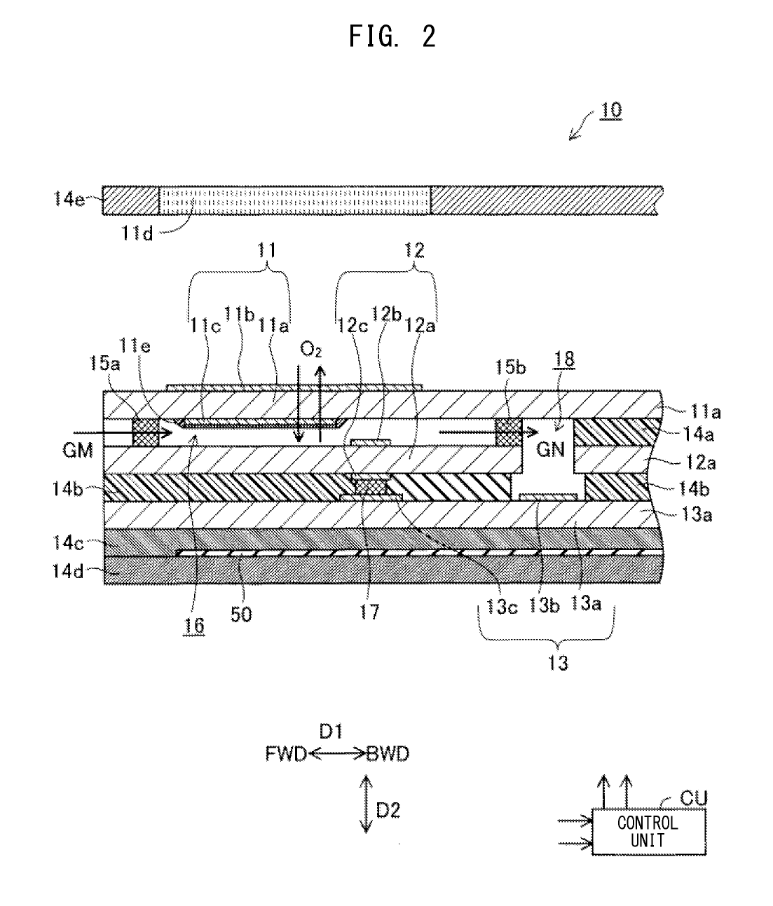

FIG. 2 is a sectional view of the NOₓ sensor element 10. The sectional view is in parallel with the longitudinal direction D1. In FIG. 2, the leftward direction corresponds to the forward direction (forward side) FWD of the NOₓ sensor element 10, and the rightward direction corresponds to the backward direction (backward side) BWD of the NOₓ sensor element 10. The NOₓ sensor element 10 has a structure in which an insulation layer 14e, a first solid electrolyte layer 11a, an insulation layer 14a, a second solid electrolyte layer 12a, an insulation layer 14b, a third solid electrolyte layer 13a, and insulation layers 14c and 14d are laminated together in this order. These layers are laminated along a direction D2 of lamination perpendicular to the longitudinal direction D1. In FIG. 2, for convenience of explanation, the insulation layer 14e is separated from the first solid electrolyte layer 11a. However, in actuality, the insulation layer 14e is laminated on the first solid electrolyte layer 11a. The insulation layer 14e, the first solid electrolyte layer 11a, the insulation layer 14a, the second solid electrolyte layer 12a, the insulation layer 14b, the third solid electrolyte layer 13a, and the insulation layers 14c, 14d, and 14e correspond to the claimed “ceramic layers.” The insulation layers 14d and 14e correspond to the claimed “outermost layer.”

A first measuring chamber 16 is formed between the first solid electrolyte layer 11a and the second electrolyte layer 12a. A gas GM to be measured is externally introduced into the first measuring chamber 16 via a first diffusion resistor 15a disposed at the left end (inlet) of the first measuring chamber 16. A second diffusion resistor 15b is disposed at an end of the first measuring chamber 16 opposite the inlet.

A second measuring chamber 18 is formed to the right of the first measuring chamber 16 and communicates with the first measuring chamber 16 via the second diffusion resistor 15b. The second measuring chamber 18 extends through the second solid electrolyte layer 12a and is formed between the first solid electrolyte layer 11a and the third solid electrolyte layer 13a.

A heater 50 is embedded between the insulation layers 14c and 14d and extends along the longitudinal direction D1. The heater 50 heats the gas sensor element 10 to a predetermined activation temperature for stabilizing operation by enhancing the oxygen ion conductivity of the solid electrolyte layers. The heater 50 is a heat-generating resistor formed from a conductive material, such as tungsten, and generates heat by means of supplied electric power. The heater 50 is supported by the two layers 14c and 14d. The heater 50 corresponds to the claimed “heat-generating resistor.”

In the present embodiment, the solid electrolyte layers 11a, 12a, and 13a are formed from zirconia, which has oxygen ion conductivity, as a main component. The insulation layers 14a to 14e are formed from alumina as a main component. The first diffusion resistor 15a and the second diffusion resistor 15b are formed from a porous material, such as alumina. As used herein, a “main component” means “a main material contained in an amount of 50 wt % or higher in a ceramic layer.” For example, the expression “the solid electrolyte layers are formed from zirconia as a main component” means that the solid electrolyte layers contain zirconia in an amount of 50 wt % or higher. Among eight solid electrolyte layers and insulation layers, the six layers 14e, 11a, 12a, 13a, 14c and 14d are formed from respective material sheets (e.g., sheets of ceramic, such as zirconia or alumina). The two insulation layers 14a and 14b are formed by screen printing on respective ceramic sheets. A laminate of green layers is fired, thereby forming the NOₓ sensor element 10.

The gas sensor element 10 has a first pumping cell 11, an oxygen concentration detection cell 12, and a second pumping cell 13.

The first pumping cell 11 includes the first solid electrolyte layer 11a, an inner first pump electrode 11c, and a first counter electrode (outer first pump electrode) 11b, which is a counter electrode of the inner first pump electrode 11c. The inner first pump electrode 11c and the outer first pump electrode 11b are disposed so as to hold the first solid electrolyte layer 11a therebetween. The inner first pump electrode 11c faces the first measuring chamber 16. Platinum is predominantly used to form the inner first pump electrode 11c and the outer first pump electrode 11b. The surface of the inner first pump electrode 11c is covered with a protection layer 11e formed from a porous material. The outer first pump electrode 11b is covered with a porous material 11d (e.g., alumina) which is embedded in the insulation layer 14e at a portion facing the outer first pump electrode 11b and allows passage of gas (e.g., oxygen).

The oxygen concentration detection cell 12 includes the second solid electrolyte layer 12a, a detection electrode 12b, and a reference electrode 12c. The detection electrode 12b and the reference electrode 12c are disposed so as to hold the second solid electrolyte layer 12a therebetween. The detection electrode 12b is located downstream of the inner first pump electrode 11c and faces the first measuring chamber 16. Platinum is predominantly used to form the detection electrode 12b and the reference electrode 12c.

The insulation layer 14b has a cutout formed so as to accommodate the reference electrode 12c in contact with the second solid electrolyte layer 12a. The cutout is filled with a porous material, thereby forming a reference oxygen chamber 17. Application of an extremely slight constant current to the oxygen concentration detection cell 12 transfers oxygen into the reference oxygen chamber 17 from the first measuring chamber 16. In this manner, the oxygen concentration of the reference oxygen chamber 17 is maintained at a predetermined level. Thus, the oxygen concentration of the reference oxygen chamber 17 is utilized as a reference oxygen concentration.

The second pumping cell 13 includes the third solid electrolyte layer 13a, an inner second pump electrode 13b disposed on a surface of the third solid electrolyte layer 13a which faces the second measuring chamber 18, and a second counter electrode (counter second pump electrode) 13c, which is a counter electrode of the inner second pump electrode 13b. Platinum is predominantly used to form the inner second pump electrode 13b and the counter second pump electrode 13c. The counter second pump electrode 13c is disposed on a portion of the third solid electrolyte layer 13a which corresponds to the cutout of the insulation layer 14b, and faces the reference electrode 12c with the reference oxygen chamber 17 therebetween. Each of the first solid electrolyte layer 11a, the second solid electrolyte layer 12a and the third solid electrolyte layer 13a corresponds to the claimed “solid electrolyte layer”. Each of a pair consisting of the inner first pump electrode 11c and the outer first pump electrode 11b, a pair consisting of the detection electrode 12b and the reference electrode 12c, and a pair consisting of the inner second pump electrode 13b and the counter second pump electrode 13c corresponds to the claimed “a pair of electrodes” of the corresponding solid electrolyte layer.

FIG. 2 also shows a control unit CU for the NOₓ sensor 200 (NOₓ sensor element 10). The heater 50 and the electrodes 11b, 11c, 12b, 12c, 13b and 13c are connected to the control unit CU via the connection terminals 110 and the lead wires 146 shown in FIG. 1. As described below, the control unit CU supplies power to the heater 50. The control unit CU sends signals to and receives signals from the electrodes 11b, 11c, 12b, 12c, 13b and 13c, thereby controlling the NOₓ sensor 200 (NOₓ sensor element 10). In the present embodiment, the control unit CU is an electronic circuit formed of an operational amplifier, etc. The control unit CU may also comprise a computer having a CPU and a memory.

Next, an example operation of the NOₓ sensor element 10 is described. First, when an engine is started, the control unit CU is started. The control unit CU supplies power to the heater 50. The heater 50 heats the first pumping cell 11, the oxygen concentration detection cell 12, and the second pumping cell 13 to an activation temperature. When the cells 11 to 13 are heated to the activation temperature, the control unit CU applies current to the first pumping cell 11. In this manner, the first pumping cell 11 pumps out excess oxygen contained in a gas GM to be measured (exhaust gas) which is introduced into the first measuring chamber 16, from the inner first pump electrode 11c toward the first counter electrode 11b.

The control unit CU controls the electrode-to-electrode voltage (terminal-to-terminal voltage) of the first pumping cell 11 so that the electrode-to-electrode voltage (terminal-to-terminal voltage) of the oxygen concentration detection cell 12 assumes a constant voltage V1 (e.g., 425 mV). The voltage of the oxygen concentration detection cell 12 indicates the oxygen concentration of the detection electrode 12b. This control adjusts the oxygen concentration of the first measuring chamber 16 to a level which does not decompose NOₓ.

The gas GN to be measured whose oxygen concentration has been adjusted flows toward the second measuring chamber 18. The control unit CU applies an electrode-to-electrode voltage (terminal-to-terminal voltage) to the second pumping cell 13. The voltage is set to a constant voltage sufficiently high to decompose NOₓ contained in the gas GN to be measured into oxygen and nitrogen (i.e., a voltage higher than the control voltage of the oxygen concentration detection cell 12; e.g., 450 mV). By application of this voltage, NOₓ contained in the gas GN to be measured is decomposed into nitrogen and oxygen.

The control unit CU applies a second pump current to the second pumping cell 13 so as to pump out oxygen generated due to decomposition of NOₓ from the second measuring chamber 18. Since there is a linear relationship between the second pump current and the NOₓ concentration, by detecting the current, the NOₓ concentration of the gas GN to be measured can be detected.

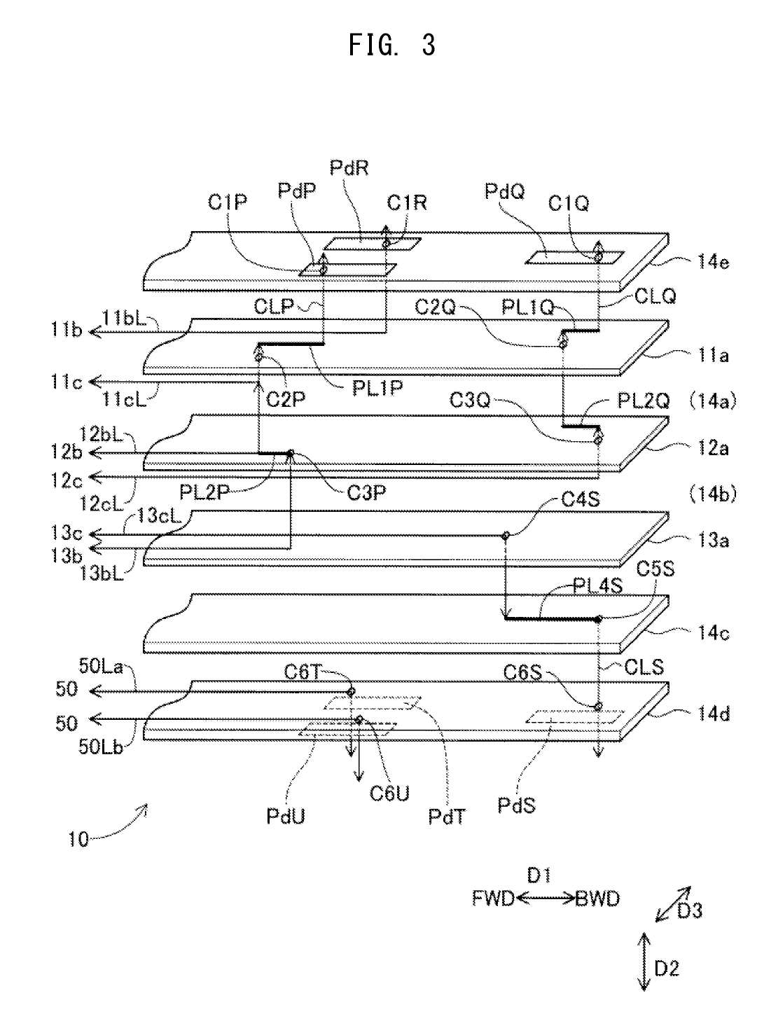

FIG. 3 is an exploded perspective view of the NOₓ sensor element 10. FIG. 3 shows a backward end portion of the NOₓ sensor element 10. FIG. 3 omits illustration of the two insulation layers 14a and 14b and illustrates the six ceramic layers 14e, 11a, 12a, 13a, 14c and 14d.

Three electrode pads PdP, PdQ and PdR are formed on the outer surface of the insulation layer 14e (the outer surface is a surface opposite a surface in contact with the first solid electrolyte layer 11a). The insulation layer 14e has three through holes C1P, C1Q, and C1R formed therein. As viewed from the laminating direction D2, the three through holes C1P, C1Q and C1R are formed in the three electrode pads PdP, PdQ and PdR, respectively. Each of the through holes corresponds to the claimed “penetrating hole” A through hole conductor is formed in each of the through holes. The description of the through hole conductor is omitted.

The first solid electrolyte layer 11a has two through holes C2P and C2Q formed therein. Two connection lines PL1P and PL1Q are formed between two ceramic layers 14e and 11a. The first connection line PL1P connects the first through hole C1P of the insulation layer 14e and the first through hole C2P of the first solid electrolyte layer 11a. The second connection line PL1Q connects the second through hole C1Q of the insulation layer 14e and the second through hole C2Q of the first solid electrolyte layer 11a. A connection line 11bL is also formed between the two ceramic layers 14e and 11a for connecting the through hole C1Q and the outer first pump electrode 11b (FIG. 2).

The second solid electrolyte layer 12a has two through holes C3P and C3Q formed therein. Two connection lines PL2P and PL2Q are formed between two ceramic layers 11a and 12a. The first connection line PL2P connects the first through hole C2P of the first solid electrolyte layer 11a and the first through hole C3P of the second solid electrolyte layer 12a. The second connection line PL2Q connects the second through hole C2Q of the first solid electrolyte layer 11a and the second through hole C3Q of the second solid electrolyte layer 12a. Two connection lines 11cL and 12bL are further formed between the two ceramic layers 11a and 12a. The pump electrode line 11cL connects the inner first pump electrode 11c (FIG. 2) and the first through hole C2P of the first solid electrolyte layer 11a. The detection electrode line 12bL connects the detection electrode 12b (FIG. 2) and the first through hole C3P of the second solid electrolyte layer 12a.

The insulation layer 14a (FIG. 2) is disposed between the first solid electrolyte layer 11a and the second solid electrolyte layer 12a. The pump electrode line 11cL is formed between the first solid electrolyte layer 11a and the insulation layer 14a. The detection electrode line 12bL is formed between the insulation layer 14a and the second solid electrolyte layer 12a. Notably, the insulation layer 14a is not formed in a region where the connection lines PL2P and PL2Q are formed. That is, the insulation layer 14a is formed so as to avoid the two connection lines PL2P and PL2Q. In this manner, the connection lines PL2P and PL2Q are formed in contact with both the first solid electrolyte layer 11a and the second solid electrolyte layer 12a.

The third solid electrolyte layer 13a has one through hole C4S formed therein. Three connection lines 12cL, 13cL and 13bL are formed between the two ceramic layers 12a and 13a. The first connection line 12cL connects the reference electrode 12c (FIG. 2) and the second through hole C3Q of the second solid electrolyte layer 12a. The second connection line 13cL connects the counter second pump electrode 13c (FIG. 2) and the through hole C4S of the third solid electrolyte layer 13a. The third connection line 13bL connects the inner second pump electrode 13b (FIG. 2) and the first through hole C3P of the second solid electrolyte layer 12a.

The insulation layer 14b (FIG. 2) is disposed between the second solid electrolyte layer 12a and the third solid electrolyte layer 13a. The first connection line 12cL is formed between the second solid electrolyte layer 12a and the insulation layer 14b. The second and third connection lines 13cL and 13bL are formed between the insulation layer 14b and the third solid electrolyte layer 13a.

The insulation layer 14c has one through hole C5S. A connection line PL4S is formed between the third solid electrolyte layer 13a and the insulation layer 14c for connecting the through hole C5S and the through hole C4S of the third solid electrolyte layer 13a.

The insulation layer 14d has three through holes C6S, C6T and C6U formed therein. Three electrode pads PdS, PdT and PdU are formed on the outer surface of the insulation layer 14d (the outer surface is a surface opposite a surface in contact with the insulation layer 14c). As viewed from the laminating direction D2, the three through holes C6S, C6T and C6U are formed in the three electrode pads PdS, PdT and PdU, respectively.

Two connection lines 50La and 50Lb are formed between the insulation layer 14c and the insulation layer 14d. The first connection line 50La connects the first through hole C6T and the heater 50 (FIG. 2). The second connection line 50Lb connects the second through hole C6U and the heater 50.

Three conductive paths CLP, CLQ and CLS are shown in FIG. 3. The first conductive path CLP passes through the three through holes C1P, C2P and C3P. The first conductive path CLP starts from the first electrode pad PdP; passes through the through hole C1P, the connection line PL1P, the through hole C2P and the connection line PL2P; and reaches the through hole C3P. The first conductive path CLP allows the first electrode pad PdP to be utilized as a common pad among the inner first pump electrode 11c, the detection electrode 12b and the inner second pump electrode 13b.

The second conductive path CLQ passes through the three through holes C1Q, C2Q and C3Q. The second conductive path CLQ starts from the second electrode pad PdQ; passes through the through hole C1Q, the connection line PL1Q, the through hole C2Q and the connection line PL2Q; and reaches the through hole C3Q. The second conductive path CLQ allows the second electrode pad PdQ to be utilized as a pad for the reference electrode 12c.

The third conductive path CLS passes through the three through holes C6S, C5S and C4S. The third conductive path CLS starts from the electrode pad PdS; passes through the through hole C6S, the through hole C5S and the connection line PL4S; and reaches the through hole C4S. The third conductive path CLS allows the electrode pad PdS to be utilized as a pad for the counter second pump electrode 13c.

The connection lines shown in FIG. 3 are formed from a conductive material (e.g., platinum or nickel). Various methods (e.g., screen printing) are available for forming the connection lines. Also, various methods are available for forming the through holes shown in FIG. 3. For example, the through holes may be formed by cutting holes in green ceramic sheets. Before firing, the through holes are filled with a conductive paste. In this manner, through hole conductors are formed by firing.

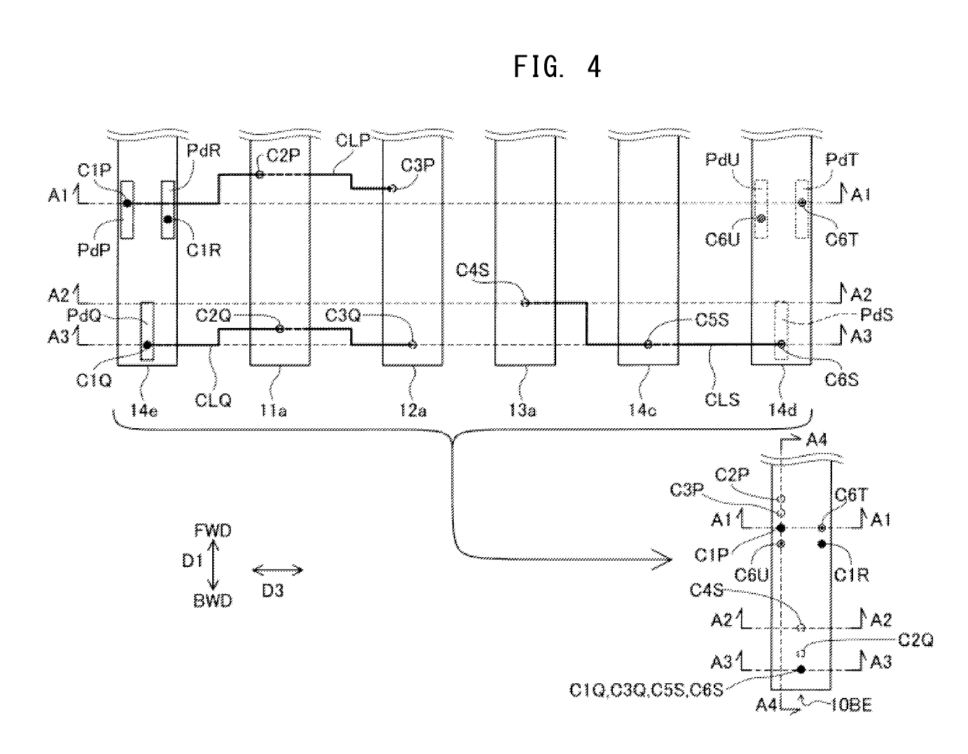

FIG. 4 is an explanatory view showing through hole positions as viewed from the laminating direction D2. FIG. 4 individually shows the six ceramic layers 14e, 11a, 12a, 13a, 14c and 14d shown in FIG. 3, as well as a projection view in which, in the laminated condition of the six ceramic layers, through holes formed in the five ceramic layers 14e, 11a, 12a, 13a and 14c project onto the insulation layer 14d along the laminating direction. FIG. 4 is a view from the insulation layer 14e toward the insulation layer 14d. In the projection view, heavy dots indicate through holes formed in the insulation layer 14e; double circles indicate through holes formed in the insulation layer 14d; and broken-line circles indicate through holes formed in the interior of the gas sensor element 10.

The second electrode pad PdQ is formed in a central region of a backward end portion (end portion in the backward direction BWD) of the insulation layer 14e. The two electrode pads PdP and PdR are formed in a region shifted from the second electrode pad PdQ in the forward direction FWD. The first electrode pad PdP is disposed on one side with respect to a lateral direction D3 (on the left side in FIG. 4), and the third electrode pad PdR is disposed on the other side with respect to the lateral direction D3 (on the right side in FIG. 4). The lateral direction D3 is perpendicular to both the longitudinal direction D1 and the laminating direction D2.

As viewed from the laminating direction D2, the three electrode pads PdU, PdS and PdT formed on the insulation layer 14d overlie the three electrode pads PdP, PdQ and PdR, respectively, formed on the insulation layer 14e.

The three through holes C1P, C2P and C3P forming the first conductive path CLP are disposed along the longitudinal direction D1 on one side with respect to the lateral direction D3 of the gas sensor element 10 (on the left side in FIG. 4). As viewed from the laminating direction D2, these through holes C1P, C2P, and C3P are disposed so as not to overlap one another. The first conductive path CLP corresponds to the claimed “type 1 conductive path.” By forming the first conductive path CLP in the NOₓ sensor element 10 in this manner, as viewed from the laminating direction D2, a plurality of through holes used to form a type 1 conductive path; specifically, the through holes C1P, C2P and C3P, are not disposed on the same straight line in parallel with the laminating direction D2. Thus, even when the NOₓ sensor element 10 vibrates upon exposure to external shock or vibration, the generation of cracks or the like is restrained, whereby the strength of the NOₓ sensor element 10 can be retained.

According to the present embodiment, the through hole C3P of the second solid electrolyte layer 12a is disposed so as to be shifted from the through hole C1P of the insulation layer 14e in the forward direction FWD. The through hole C2P of the first solid electrolyte layer 11a is disposed so as to be shifted from the through hole C3P in the forward direction FWD. In this manner, the three through holes C1P, C2P and C3P used to form the first conductive path CLP are disposed so as to be shifted from one another in the longitudinal direction D1. That is, a plurality of through holes C1P, C2P and C3P used to form the first conductive path (type 1 conductive path) CLP are not disposed along the lateral direction D3. As a result, as viewed on an imaginary section of the gas sensor element 10 taken perpendicular to the longitudinal direction D1 (taken in parallel with the lateral direction D3) and passing through one of a plurality of the through holes used to form the first conductive path CLP (e.g., an imaginary section taken along line A1-A1 of FIG. 4), a problem of the NOₓ sensor element 10 having a region of an excessively high occupancy rate (areal rate) of through holes can be prevented. Thus, even when the NOₓ sensor element 10 vibrates as a result of exposure to external shock or vibration, the generation of cracks or the like is restrained, whereby the strength of the NOₓ sensor element 10 can be retained. The through hole C6U of the insulation layer 14d is disposed so as to be shifted from the through hole C1P of the insulation layer 14e in the backward direction BWD.

The three through holes C1Q, C2Q, and C3Q used to form the second conductive path CLQ are disposed along the longitudinal direction D1 in a central region of a backward end 10BE of the gas sensor element 10. The two through holes C1Q and C3Q are disposed at the same position. The remaining through hole C2Q is disposed so as to be shifted from the two through holes C1Q and C3Q in the forward direction FWD.

The three through holes C4S, C5S and C6S used to form the third conductive path CLS are also disposed along the longitudinal direction D1 in a central region of the backward end 10BE of the gas sensor element 10. The two through holes C5S and C6S, and the through holes C1Q and C3Q of the second conductive path CLQ are disposed at the same position. The remaining through hole C4S is disposed so as to be shifted from the through hole C2Q of the first solid electrolyte layer 11a in the forward direction FWD.

The through hole C1R of the insulation layer 14e is disposed on the other side with respect to the lateral direction D3 (on the right side in FIG. 4). The first through hole C6T of the insulation layer 14d is disposed so as to be shifted from the through hole C1R in the forward direction FWD.

As shown in FIG. 4, as viewed on an imaginary section (e.g., each of imaginary sections A1, A2 and A3) of the gas sensor element 10 taken perpendicular to the longitudinal direction D1 (taken in parallel with the lateral direction D3 (a direction perpendicular to both the longitudinal direction D1 and the laminating direction D2)), the number of the through holes appearing in each of six ceramic layers (the number of through holes intersecting with a single imaginary section) is at most one. That is, in each of the six ceramic layers, through holes are not disposed along the lateral direction D3. As a result, as viewed on the imaginary sections A1, A2 and A3, a problem of the NOₓ sensor element 10 having a region of an excessively high occupancy rate (areal rate) of through holes can be prevented. Thus, even when the NOₓ sensor element 10 vibrates as a result of exposure to external shock or vibration, the generation of cracks or the like is restrained, whereby the strength of the NOₓ sensor element 10 can be retained.

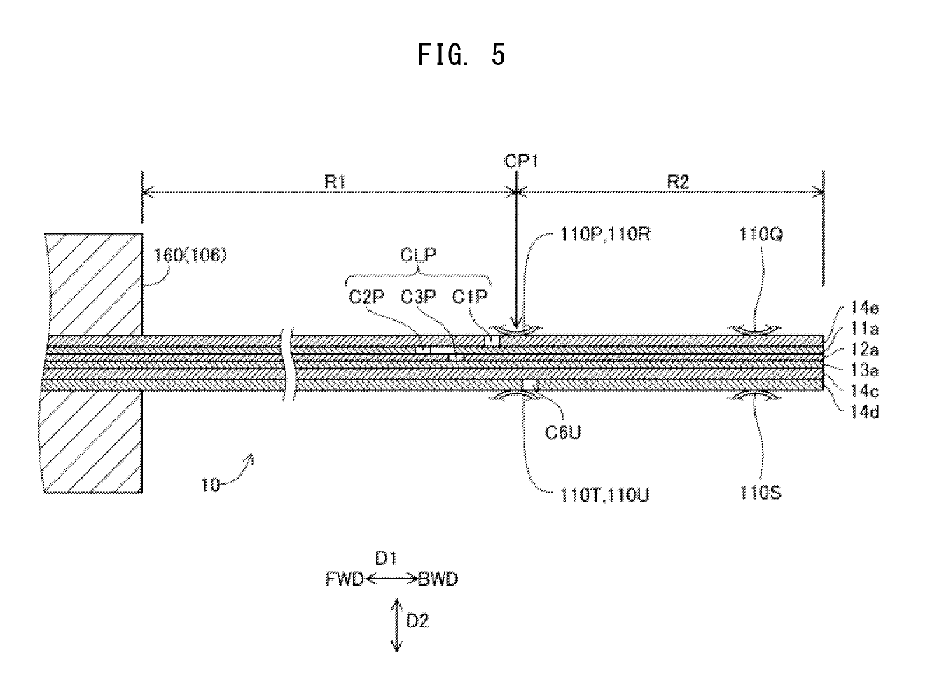

FIG. 5 is an explanatory sectional view of the NOₓ sensor element 10 taken along the longitudinal direction D1 and passing through the through hole C1P (a section taken along line A4-A4 of FIG. 4) as viewed from the lateral direction D3, showing through hole positions. FIG. 5 shows a backward end portion of the gas sensor element 10, and a portion of the gas sensor element 10 supported by the holding section 160 (the ceramic sleeve 106). FIG. 5 shows the six ceramic layers shown in FIG. 3 and the through holes provided in the ceramic layers.

FIG. 5 shows some of six connection terminals 110P, 110Q, 110R, 110S, 110T and 110U. These connection terminals 110P, 110Q, 110R, 110S, 110T and 110U are in contact with the electrode pads PdP, PdQ, PdR, PdS, PdT and PdU (FIG. 4), respectively. In FIG. 1, the six connection terminals 110P, 110Q, 110R, 110S, 110T and 110U are denoted by the common reference numeral “110.”

An illustrated position CP1 is a contact position along the longitudinal direction D1 located closest to the holding section 160 among six contact positions between the connection terminals 110P to 110U and the electrode pads PdP to PdU. In the present embodiment, the four connection terminals 110P, 110R, 110T and 110U are in contact with the four electrode pads PdP, PdR, PdT and PdU, respectively, at the position CP 1.

In FIG. 5, a first positional range R1 along the longitudinal direction D1 ranges from the position CP1 to a holding position where the holding section 160 holds the NOₓ sensor element 10 (particularly, a holding position located closest to the position CP1). In the present embodiment, three through holes C1P, C2P and C3P through which the first conductive path CLP (FIGS. 3 and 4) passes are disposed within the first positional range R1. This is for the following reason. For example, when the connection terminal 110 is subjected to external shock or vibration, the connection terminal 110 imposes force on the NOₓ sensor element 10 at the position CP1. As a result, the NOₓ sensor element 10 vibrates, whereas the holding position is held by the holding section 160 which serves as a fixed end. Thus, cracking or the like is likely to occur, starting from a through hole disposed within the first positional range R1. Therefore, when a conductive path passing through a plurality of ceramic layers is to be formed within the first positional range R1, preferably, as in the case of the present embodiment, the conductive path is made the first conductive path CLP. This configuration yields the following effect as compared with a configuration in which, as viewed from the laminating direction D2, through holes within the first positional range R1 overlie one another: even when the NOₓ sensor element 10 vibrates as a result of exposure to external shock or vibration, cracking or the like starting from the through holes C1P, C2P and C3P disposed within the first positional range R1 is restrained, whereby the shock resistance of the NOₓ sensor element 10 can be retained. Since conductive paths can be formed within the first positional range R1 as mentioned above while the strength of the NOₓ sensor element 10 is retained, the degree of freedom of design of the NOₓ sensor element 10 can be enhanced. Also, through holes can be disposed closer to respective objects of connection (e.g., the inner first pump electrode 11c and the inner second pump electrode 13b) in the NOₓ sensor element 10. As a result, lines for connecting through holes to respective objects of connection can be shortened. Thus, material used to form the lines can be saved.

In the present embodiment, no holding section is provided on a side opposite the holding section 160 with respect to the position CP1 (in the backward direction BWD from the position CP1). Thus, for example, even when external shock or vibration imparts a force on the NOₓ sensor element 10 at the position CP1, in contrast to the first positional range R1, in a second positional range R2 which extends from the position CP1 in the backward direction BWD, an associated portion of the NOₓ sensor element 10 follows the vibration. Consequently, cracking or the like is unlikely to occur, starting from a through hole. As shown in FIG. 4, according to the present embodiment, as viewed from the laminating direction D2, the four through holes C1Q, C3Q, C5S and C6S disposed at the backward end 10BE of the NOₓ sensor element 10 overlie one another. However, in spite of such an overlying arrangement of the four through holes, even when the NOₓ sensor element 10 vibrates as a result of exposure to external shock or vibration, cracking or the like starting from the four through holes is restrained, whereby excessive impairment in shock resistance of the NOₓ sensor element 10 can be prevented. By employing through holes formed in two adjacent layers and overlying each other, the through holes can be readily connected together without the need for use a connection line extending between the two layers.

### B. Second Embodiment

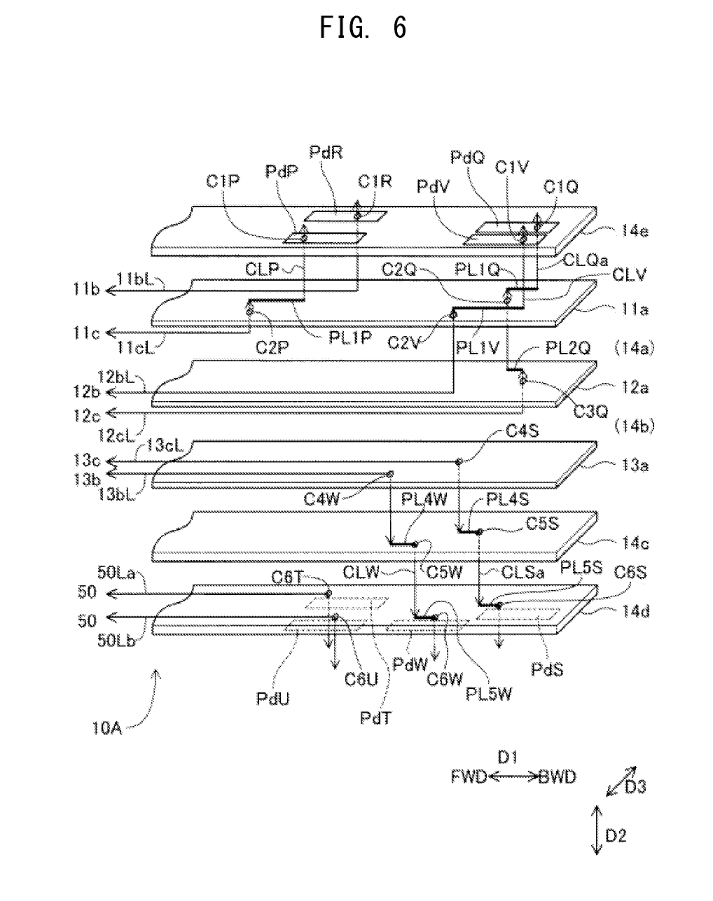

FIG. 6 is an exploded perspective view of another embodiment of the NOₓ sensor element of the present invention. An NOₓ sensor element 10A of FIG. 6 differs from the NOₓ sensor element 10 of the first embodiment shown in FIG. 3 in four points. A first difference is that a conductive path CLV and an electrode pad PdV are formed for the detection electrode 12b. A second difference is that a conductive path CLW and an electrode pad PdW are formed for the inner second pump electrode 13b. A third difference is that the connection line PL2P and the through hole C3P are eliminated. A fourth difference is that the three through holes C3Q, C5S and C6S are shifted from one another in the longitudinal direction D1 so as not to overlie one another as viewed from the laminating direction D2. Other configurational features are similar to those of the NOₓ sensor element 10 of the first embodiment shown in FIG. 3. The NO sensor element 10A can replace the gas sensor element 10 of the first embodiment for use in the gas sensor 200 shown in FIG. 1. In this case, two connection terminals contacting the additional two respective electrode pads PdV and PdW are added. Additionally, eight lead wires 146 connected to the eight respective connection terminals are used.

First, the conductive path CLV is described. The electrode pad PdV is formed on the outer surface of the insulation layer 14e. The electrode pad PdV is disposed on a side opposite the second electrode pad PdQ (on a near side in FIG. 6) with respect to the lateral direction D3. A through hole C1V is formed in the insulation layer 14e. The through hole C1V is disposed within and connected to the electrode pad PdV. A through hole C2V is formed in the first solid electrolyte layer 11a adjacent to the insulation layer 14e. A connection line PL1V is formed between the two ceramic layers 14e and 11a for connecting the two through holes C1V and C2V. The detection electrode line 12bL is connected to the through hole C2V on a side of the first solid electrolyte layer 11a opposite the insulation layer 14e. The conductive path CLV passes through the two through holes C1V and C2V. The conductive path CLV allows the electrode pad PdV to be utilized as a pad for the detection electrode 12b.

Next, the conductive path CLW is described. The electrode pad PdW is formed in the outer surface of the insulation layer 14d. The electrode pad PdW is disposed so as to be shifted from the electrode pad PdU in the backward direction BWD. A through hole C6W is formed in the insulation layer 14d. The through hole C6W is disposed within and connected to the electrode pad PdW. A through hole C5W is formed in the insulation layer 14c adjacent to the insulation layer 14d. A connection line PL5W is formed between the two ceramic layers 14c and 14d for connecting the two through holes C5W and C6W. A through hole C4W is formed in the third solid electrolyte layer 13a adjacent to the insulation layer 14c. A connection line PL4W is formed between the two ceramic layers 13a and 14c for connecting the two through holes C4W and C5W. The third connection line 13bL is connected to the through hole C4W on a side of the third solid electrolyte layer 13a opposite the insulation layer 14c. The conductive path CLW passes through the three through holes C4W, C5W and C6W. The conductive path CLW allows the electrode pad PdW to be utilized as a pad for the inner second pump electrode 13b.

Next, a conductive path CLSa is described. In the present embodiment, the through hole C6S of the insulation layer 14d is shifted from that shown in FIG. 3 in the forward direction FWD. As for position in the longitudinal direction D1, the through hole C5S of the insulation layer 14c is located between the two through holes C4S and C6S. A connection line PL5S is formed between the two ceramic layers 14c and 14d for connecting the two through holes C5S and C6S. The conductive path CLSa passes through the three through holes C4S, C5S and C6S. The conductive path CLSa allows the electrode pad PdS to be utilized as a pad for the counter second pump electrode 13c.

Next, a conductive path CLQa is described. In the present embodiment, the through hole C3Q of the second solid electrolyte layer 12a is shifted from that shown in FIG. 3 in the forward direction FWD. Other configurational features are similar to those of the second conductive path CLQ shown in FIG. 3.

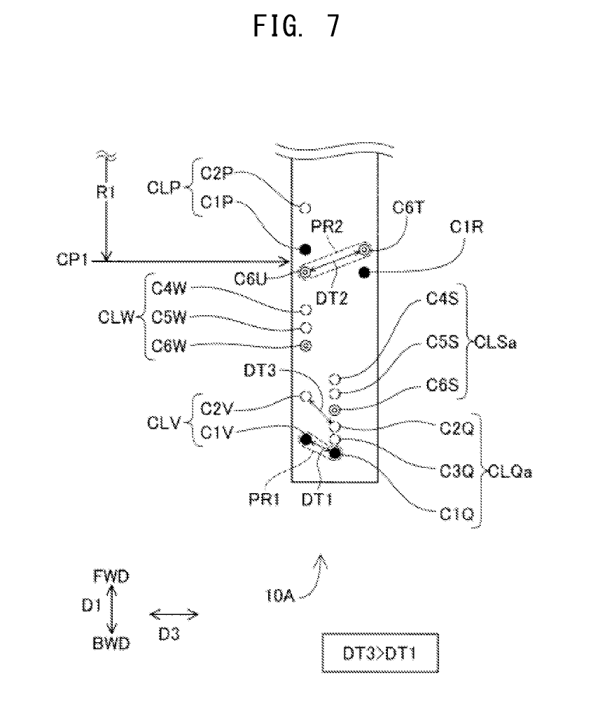

FIG. 7 is an explanatory view showing through hole positions as viewed from the laminating direction D2. Similar to FIG. 4, FIG. 7 contains a projection view of the NO sensor element 10A. In FIG. 7, heavy dots indicate through holes formed in the insulation layer 14e; double circles indicate through holes formed in the insulation layer 14d; and broken-line circles indicate through holes formed in the interior of the gas sensor element 10A.

As shown in FIG. 7, in the present embodiment, as viewed from the laminating direction D2, all through holes are disposed so as not to overlie one another. That is, all of the conductive paths CLP, CLQa, CLV, CLSa and CLW passing through through holes formed in a plurality of layers each corresponds to the claimed “type 1 conductive path.” Thus, as viewed from the laminating direction D2, the through holes are never disposed on the same straight line in parallel with the laminating direction D2 (a direction perpendicular to both the longitudinal direction D1 and the lateral direction D3). Therefore, even when the NOₓ sensor element 10A vibrates upon exposure to external shock or vibration, the generation of cracks or the like is sufficiently restrained, whereby the strength of the NOₓ sensor element 10A can be sufficiently retained.

Also, a plurality of through holes through which each of the conductive paths CLP, CLQa, CLV, CLSa and CLW passes differ from one another in position along the longitudinal direction D1. Thus, the strength of the NOₓ sensor element 10A can be made higher than that of the NOₓ sensor element 10 shown in FIG. 4.

Further, among pairs each consisting of any two of the four through holes C1P, C1Q, C1R and C1V formed in the insulation layer 14e, a pair consisting of two through holes located closest to each other is a first pair PR1 (through holes C1V and C1Q). A first distance DT1 is the shortest distance between the through holes C1V and C1Q of the first pair PR1. Among pairs each consisting of any two of the four through holes C6S, C6T, C6U and C6W formed in the insulation layer 14d, a pair consisting of two through holes located closest to each other is a second pair PR2 (through holes C6T and C6U). A second distance DT2 is the shortest distance between the through holes C6T and C6U of the second pair PR2. In the present embodiment, DT1 is shorter than DT2 (DT1<DT2). Thus, among pairs each consisting of any of two through holes formed in the insulation layers 14e and 14d, a pair consisting of two through holes located closest to each other is the first pair PR1. In the present embodiment, the two through holes C1Q and C1V which constitute the first pair PR1 are electrically connected to different type 1 conductive paths CLQa and CLV, respectively. Thus, since the two conductive paths CLQa and CLV located closest to each other are type 1 conductive paths, even when the NOₓ sensor element 10A vibrates upon exposure to external shock or vibration, the generation of cracks or the like starting from two through holes formed closest to each other in one of the outermost layers is restrained, whereby the strength of the NOₓ sensor element 10A can be retained.

Further, a third distance DT3 is shown in FIG. 7. The third distance DT3 is the shortest distance between the two through holes C2Q and C2V formed in the first solid electrolyte layer 11a. In the present embodiment, DT3 is longer than DT1 (DT3>DT1). Since the third distance DT3 is long, leakage of current through the solid electrolyte layer 11a between the two through holes C2Q and C2V can be restrained. Further, since the first distance DT1 (distance between the two through holes C1V and C1Q) is short, the two electrode pads PdQ and PdV can be formed close to each other. Thus, the space required for disposing connection terminals in contact with the respective electrode pads PdQ and PdV can be reduced. A combination of two conductive paths having this feature is not limited to a combination of the two conductive paths CLQa and CLU, and a combination of two other conductive paths may have this feature.

Further, the position CP1 and the first positional range R1 are shown in FIG. 7. The position CP1 and the first positional range R1 have the same meaning as the position CP1 and the first positional range R1, respectively, shown in FIG. 5. As shown in FIG. 7, the position along the longitudinal direction D1 of each of the two through holes C1P and C2P used to form the first conductive path CLP is set within the first positional range R1. Thus, the NOₓ sensor element 10A of the present embodiment provides various advantages similar to those of the NOₓ sensor element 10 of the first embodiment.

### C. Third Embodiment

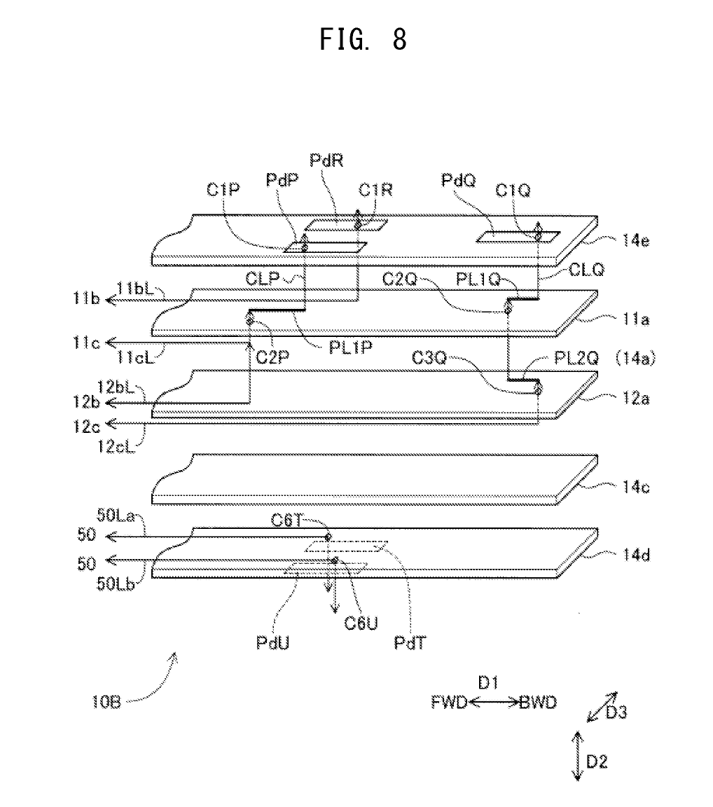

FIG. 8 is an exploded perspective view of another embodiment of the gas sensor element of the present invention. A perspective view similar to that of FIG. 3 is shown in FIG. 8. A gas sensor element 10B of the present embodiment is an air-fuel ratio sensor for measuring an air-fuel ratio. The configuration of this air-fuel ratio sensor is such that the diffusion resistor 15b, the second measuring chamber 18, the insulation layer 14b, the reference oxygen chamber 17, and the second pumping cells 13 (13a, 13b and 13c) are eliminated from the configuration of the NOₓ sensor element 10 shown in FIG. 2.

As in the case of the first embodiment shown in FIG. 2, the control unit CU controls the gas sensor element 10B. The control unit CU (FIG. 2) controls the electrode-to-electrode voltage (terminal-to-terminal voltage) of the first pumping cell 11 so that the electrode-to-electrode voltage (terminal-to-terminal voltage) of the oxygen concentration detection cell 12 assumes a predetermined voltage (e.g., 450 mV). When the air-fuel ratio is higher than the theoretical air-fuel ratio (lean), current flows through the first pumping cell 11 in a direction opposite the direction of current flow in the case where the air-fuel ratio is lower than the theoretical air-fuel ratio (rich). In either case, the magnitude of current varies substantially in proportion to air-fuel ratio. Thus, by detecting the magnitude and direction of current flowing through the first pumping cell 11, the air-fuel ratio can be determined.

FIG. 8 shows a backward end portion of the gas sensor element 10B. The gas sensor element 10B differs from the gas sensor element 10 shown in FIG. 3 in that the following components are eliminated: the insulation layer 14b, the third solid electrolyte layer 13a (through hole C4S), the connection line 13cL, the connection line 13bL, the through hole C3P, the connection line PL2P, the through hole C5S, the connection line PL4S, the through hole C6S, the third conductive path CLS, and the electrode pad PdS. Other configurational features are similar to those shown in FIG. 3.

Even in the present embodiment, the first conductive path CLP also has features similar to those of the first conductive path CLP of the first embodiment (FIG. 3). Thus, the gas sensor element 10B also provides advantages similar to those of the NOₓ sensor element 10 described above.

### D. Experimental Examples

Next, the gas sensor element 10 according to the first embodiment of the present invention and a gas sensor element of a comparative example were tested for a load at which the generation of cracks is induced (breakage of element). The gas sensor element of the comparative example was formed such that, as viewed from the laminating direction D2, the through holes C1P, C2P and C3P of the first conductive path CLP overlie one another. Other configurational features of the gas sensor element of the comparative example were similar to those of the gas sensor element 10 of the first embodiment. The position of the through hole C1P of the gas sensor element of the comparative example and the position of the through hole C1P of the gas sensor element 10 of the first embodiment were identical to each other.

Each of the gas sensor elements of the first embodiment and the comparative example was disposed on two fulcrums (span: 14 mm). The gas sensor elements were disposed so as to satisfy the following conditions:

The outer surface of the insulation layer 14e is in contact with the two fulcrums.

The direction connecting the two fulcrums coincides with the longitudinal direction D1 of the gas sensor elements.

The through holes C1P of the gas sensor elements are located at the midpoint between the two fulcrums.

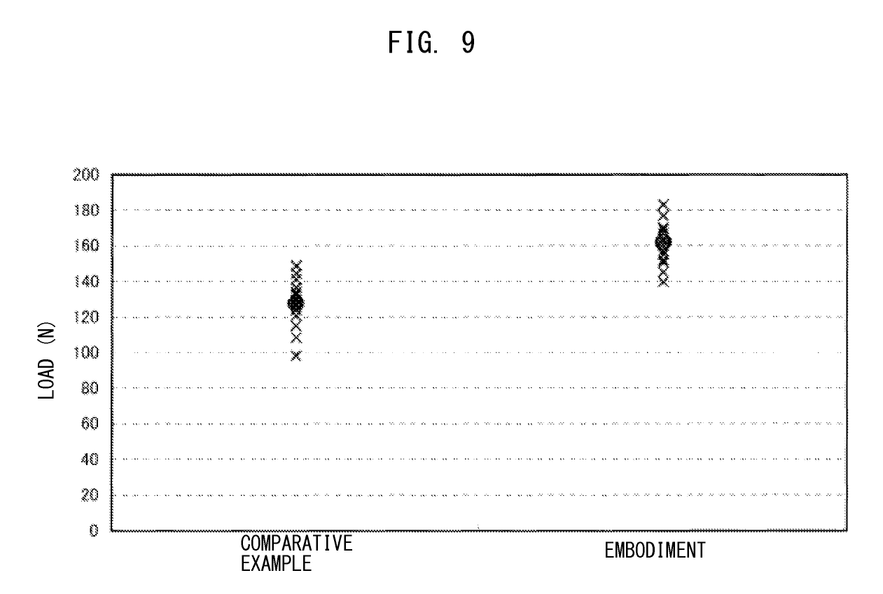

A pressing load was applied in the direction from the insulation layer 14d toward the insulation layer 14e to the outer surface of the insulation layer 14d of each of the gas sensors at a portion which, as projected in the laminating direction D2, overlies the through hole C1P; i.e., at a portion corresponding to the midpoint between the two fulcrums. The load (N) was increased until the gas sensor elements of the first embodiment and the comparative example broke. 14 pieces each of the gas sensor element of the first embodiment and the gas sensor element of the comparative example were prepared and measured for breaking load. The measurement results are shown in Table 1 and FIG. 9.

TABLE 1

| | Comparative | Embodiment |
|---|---|---|
| | Example (N) | (N) |
| Average value | 127.7 | 161.9 |
| 1 | 98.2 | 169.2 |
| 2 | 108.5 | 151.9 |
| 3 | 115.1 | 170.3 |
| 4 | 120.8 | 157.1 |
| 5 | 124.0 | 150.6 |
| 6 | 126.6 | 163.6 |
| 7 | 127.3 | 145.2 |
| 8 | 129.7 | 169.3 |
| 9 | 132.5 | 167.0 |
| 10 | 133.9 | 183.2 |
| 11 | 136.6 | 176.9 |
| 12 | 141.3 | 139.7 |
| 13 | 144.4 | 155.1 |
| 14 | 148.8 | 167.1 |

FIG. 9 shows the measured values of samples of the first embodiment and those of the comparative example as represented by X. The heavy dots indicate the averages of the measured values of the first embodiment and the comparative example, respectively. As shown in Table 1 and FIG. 9, the gas sensor elements of the first embodiment exhibited an average breaking load of about 160 N, whereas the gas sensor elements of the comparative example exhibited an average breaking load of about 130 N. The experimental results demonstrate that formation of a type 1 conductive path, as in the case of the first embodiment, restrains the generation of cracks.

### E. Modifications

The present invention is not limited to the above-described embodiments or modes, but may be embodied in various other forms without departing from the gist of the invention. For example, the following modifications may be practiced.

(1) In the above-described embodiments, penetrating holes which extend through respective ceramic layers in the direction of lamination are not limited to through holes, but may assume various other forms. For example, via holes may be employed for via connection; i.e., penetrating holes which are formed in respective ceramic layers and are filled with a conductor.

(2) In the above-described embodiments, penetrating holes may be formed in layers other than the following three kinds of layers: the solid electrolyte layers, the support layer (a layer for supporting the heat-generating resistor), and the outermost layers (layers in contact with pads). Even in this case, preferably, in order to restrain an excessive drop in strength of the gas sensor element, a conductive path which passes through a penetrating hole formed in the outermost layer and a penetrating hole formed in at least one of the solid electrolyte layer and the support layer has the following feature. Specifically, preferably, as viewed from the direction of lamination, a plurality of penetrating holes which are used to form a conductive path and formed in the respective layers of the above-mentioned three kinds do not overlie one another. A conductive path having such feature corresponds to the claimed “type 1 conductive path.”

The above-described three kinds of layers (the solid electrolyte layers, the support layer, and the outermost layers) can be formed as dense layers having little hollow space. Thus, by disposing a plurality of penetrating holes formed in respective layers of the three kinds (excluding penetrating holes formed in layers other than the three kinds of layers) having the dispositional features discussed in the above description of the embodiments, an excessive drop in strength of the gas sensor element can be restrained.

For example, preferably, the positions along the longitudinal direction of a plurality of penetrating holes used to form the type 1 conductive path and formed in respective layers of the three kinds are set within the first positional range R1 of FIG. 5 or FIG. 7. Preferably, the positions along the longitudinal direction differ from one another. Preferably, as viewed from the lateral direction, in each of the three kinds of layers, penetrating holes do not lie behind one another. As viewed from the laminating direction, a penetrating hole formed in a layer other than the three kinds of layers may overlie one of penetrating holes of the type 1 conductive path formed in one of the three kinds of layers. However, preferably, the disposition of all penetrating holes formed in all layers including layers other than the three kinds of layers have the dispositional features discussed in the above description of the embodiments. For example, preferably, as viewed in the laminating direction, all penetrating holes used to form the type 1 conductive path are disposed so as not to overlie any of the other penetrating holes formed in respective layers.

(3) In the embodiments shown in FIGS. 3, 6 and 8, all of the electrode pads may be formed on the outer surface of the insulation layer 14e. Alternatively, all of the electrode pads may be formed on the outer surface of the insulation layer 14d.

In the embodiments shown in FIGS. 5 and 7, as viewed from the laminating direction D2, penetrating holes may be formed within the first positional range R1 so as to overlie each other. However, preferably, in order to enhance the strength of the gas sensor element, such overlying penetrating holes are not formed within the first positional range R1. In the case where a plurality of conductive paths are formed within the first positional range R1, preferably, at least one of the conductive paths is a “type 1 conductive path.” Particularly preferably, all of the conductive paths formed within the first positional range R1 are “type 1 conductive paths.”

In the above-described embodiments, the electrode pads and the penetrating holes may be disposed at various positions. For example, a plurality of penetrating holes used to form a common type 1 conductive path may be disposed along the lateral direction D3. Also, the support layer for supporting the heater may be disposed between two cells. Further, various materials may be employed for forming the layers of the gas sensor.

(4) The configuration of the gas sensor is not limited to that shown in FIG. 1, and various configurations may be employed. For example, a single member may be used as the holding section 160 for holding the gas sensor element.

The gas sensor is not limited to an NOₓ sensor and an air-fuel ratio sensor, and the present invention can be applied to gas sensors for detecting various other gas components and measuring the concentration of such gas components. For example, the present invention can be applied to an oxygen concentration sensor for measuring oxygen concentration.

It should further be apparent to those skilled in the art that there is changes in form and detail of the invention as shown and described above may be made. It is intended that such changes be included within the spirit and scope of the claims appended hereto.

This application claims priority from Japanese Patent Application Nos. JP 2009-100451 filed Apr. 17, 2009 and JP 2010-050193 filed Mar. 3, 2010, the disclosures of which are incorporated herein by reference in their entirety.

What is claimed is:

1. A gas sensor comprising:
a gas sensor element having a form of a plate extending in a longitudinal direction and configured by laminating three or more ceramic layers, the gas sensor element having an electrode pad disposed on an outer surface thereof, and penetrating holes extending in a laminating direction through two or more respective ones of the ceramic layers disposed between an inner conductor provided in the gas sensor element and the electrode pad,
wherein the gas sensor element has a conductive path formed therein which passes through the penetrating holes formed in different respective ones of the ceramic layers and electrically connects the inner conductor and the electrode pad, and
the conductive path comprises a type 1 conductive path which passes through a plurality of the penetrating holes disposed so as not to overlie one another as viewed from the laminating direction.

2. The gas sensor according to claim 1, further comprising:
a terminal in contact with the electrode pad and adapted to connect the electrode pad to an external circuit, and
a holding section for holding the gas sensor element,
wherein the type 1 conductive path is disposed within a positional range between a contact position where the terminal is in contact with the electrode pad and a holding position where the holding section holds the gas sensor element.

3. The gas sensor according to claim 1, wherein, as viewed from the laminating direction, a plurality of the penetrating holes through which the type 1 conductive path passes are positionally shifted from one another at least in the longitudinal direction.

4. The gas sensor according to claim 1, wherein the gas sensor element comprises a plurality of electrode pads, and an outermost layer serving as the outer surface thereof and in contact with the plurality of the electrode pads;
the outermost layer has a plurality of penetrating holes formed therein; and
of pairs each consisting of any two of the plurality of the penetrating holes formed in the outermost layer, a pair consisting of two penetrating holes located closest to each other is used to form two conductive paths passing through the respective penetrating holes, each of which is a type 1 conductive path.

5. The gas sensor according to claim 4, wherein all of a plurality of the conductive paths passing through a plurality of the respective penetrating holes formed in the outermost layer are type 1 conductive paths.

6. The gas sensor according to claim 4, wherein, as viewed on an imaginary section of the gas sensor element taken perpendicular to the longitudinal direction, the number of penetrating holes present in each of the ceramic layers is at most one.

7. The gas sensor according to claim 4, wherein:
the outermost layer contains alumina as a main component;
the gas sensor element further comprises a solid electrolyte layer; and
the distance between the two of the plurality of the penetrating holes located closest to each other and formed in the outermost layer is shorter than a distance between two penetrating holes which are formed in the solid electrolyte layer and through which the two respective type 1 conductive paths, passing through the two penetrating holes of the outermost layer, pass.

8. The gas sensor according to claim 7, wherein the inner conductor is at least one of a heat-generating resistor for heating the gas sensor element and a pair of electrodes provided on the solid electrolyte layer and partially constituting a cell.

9. The gas sensor according to claim 1, wherein the gas sensor element further comprises a solid electrolyte layer, and
the inner conductor is at least one of a heat-generating resistor for heating the gas sensor element and a pair of electrodes provided on the solid electrolyte layer and partially constituting a cell.
